(19) United States
(12) Patent Application Publication
(10) Pub. No.: US 2006/0251761 A1
(43) Pub. Date: Nov. 9, 2006

(54) Grain wet milling process for producing dextrose

(76) Inventors: Robert Jansen, Portela (PT); John Kerr, Surrey (GB); Edward Farley, Essex (GB); Gordon Walker, Oxfordshire (GB); Sebastien Camborieux, Middlesex (GB)

Correspondence Address: WILLIAMS, MORGAN & AMERSON, 10333 RICHMOND, SUITE 1100, HOUSTON, TX, 77042, US

(21) Appl. No.: 11/121,170

(22) Filed: May 3, 2005

(51) Int. Cl. A23L 1/10

(52) U.S. Cl. 426/28

(57) ABSTRACT

Whole grain, such as wheat, barley, rye, and/or rice, can be processed by (a) steeping the grain or at least partially dehulled grain in an aqueous liquid to produce softened grain, (b) milling the softened grain to produce milled grain, (c) liquefying the milled grain by contacting it with amylase and heating it to a temperature of at least about 50° C., producing a liquefied material, (d) at least partially saccharifying the liquefied material by contacting it with amyloglucosidase at a temperature of at least about 50° C., producing a first saccharified material, and (e) separating fiber and germ from the first saccharified material, producing a screened material that is substantially free of fiber and wheat germ. The process also includes the steps of (f) further saccharifying the screened material by contacting it with amyloglucosidase at a temperature of at least about 50° C., producing a second saccharified material, (g) membrane filtering the second saccharified material, producing a permeate that comprises primarily dextrose and other soluble components and a retentate that comprises insoluble protein, and (h) purifying the permeate by chromatographic separation, producing a purified dextrose stream. The chromatographic separation can also produce a raffinate, and the process can further include the steps of (i) combining the retentate from the membrane filtration and the raffinate from the chromatographic separation to form a fermentation medium, (j) fermenting the fermentation medium aerobically with a microorganism, (k) separating a protein product that comprises insoluble protein and microorganism from the medium, and (l) drying the protein product.

### BACKGROUND OF THE INVENTION

Wheat comprises starch, germ, bran, and a protein known as gluten. It is desirable to separate the constituents of wheat into separate materials.

Wheat can be processed by dry milling wheat grains to remove the bran and the germ, then milling the remainder of the grains to produce wheat flour. The wheat flour can be further processed in order to generate separate starch, protein, and/or other products. Processing of the flour often involves separating starch from gluten. These process steps are typically done at a relatively low temperature, for example about 30° C. The starch can optionally be hydrolyzed and saccharified to produce dextrose. The gluten produced in conventional wheat processes is vital wheat gluten, which has visco-elastic properties that are valuable in some situations.

However, previously-known wheat processes have certain disadvantages. For example, the yields of starch, dextrose, and protein are not as high as might be desired. As one specific example, the yield of vital wheat gluten is relatively low (typically about 6.5 wt %). The bran, which typically makes up about 23% by weight of the wheat, is separated early in the process and takes with it a substantial amount of starch and protein. Because bran generally sells for a lower price than protein or dextrose, this problem has a negative effect on the economics of wheat processing.

Another problem with conventional wheat processes stems from the low temperatures used. At these temperatures, it is difficult to prevent the growth of microorganisms, which leads to unwanted fermentation, loss of yield and problems with product quality. In order to minimize this problem, chemical biocides are sometimes used to control micro-organisms. Caustic soda is often added to ensure that the pH does not drop too low due to the production of organic acids by the unwanted fermentation. These added chemicals often must be removed later in the processing, for example by ion exchange, which leads to the use of more acids and bases. The ash that arises from this additional processing must either be discharged from the process as an effluent, which can create environmental issues, or put into animal feed products, which can reduce their value. The use of these chemicals can also affect the functional visco-elastic properties of the vital wheat gluten, reducing its quality. An alternative to adding chemicals is to use more water rather than recycling, but this leads to extra energy costs to evaporate the extra water.

There is a need for a wheat process that reduces or eliminates one or more of the disadvantages of the prior processes.

### SUMMARY OF THE INVENTION

One aspect of the invention is a process that comprises (a) steeping at least one of wheat, barley, rye, or rice in an aqueous liquid to produce softened grain, (b) milling the softened grain to produce milled grain, (c) liquefying the milled grain by contacting it with amylase and heating it to a temperature of at least about 50° C., producing a liquefied material, (d) at least partially saccharifying the liquefied material by contacting it with amyloglucosidase at a temperature of at least about 50° C., producing a first saccharified material, and (e) separating fiber and germ from the first saccharified material, producing a screened material that is substantially free of fiber and germ. The process includes the additional steps of (f) further saccharifying the screened material by contacting it with amyloglucosidase at a temperature of at least about 50° C., producing a second saccharified material, (g) membrane filtering the second saccharified material, producing a permeate that comprises primarily dextrose and other soluble components and a retentate that comprises insoluble protein, and (h) purifying the permeate by chromatographic separation, producing a purified dextrose stream.

In one embodiment of the invention, before steeping the wheat, barley, rye, and/or rice, the grain can be at least partially dehulled by milling. This removes at least some of the bran from the grain. The partially dehulled grain can then be steeped and further processed as described above.

In one embodiment of the invention, the chromatographic separation can also produce a raffinate, and the process can further include the steps of (i) combining the retentate from the membrane filtration and the raffinate from the chromatographic separation to form a fermentation medium, (j) fermenting the fermentation medium aerobically with a microorganism, (k) separating a protein product that comprises insoluble wheat protein and microorganism from the medium, and (l) drying the protein product.

In another embodiment of the invention, in which the chromatographic separation produces a raffinate, the process can also include the steps of: (i) combining the retentate from the membrane filtration and the raffinate from the chromatographic separation to form a fermentation medium, (j) fermenting the fermentation medium anaerobically with a microorganism, whereby ethanol is produced, (k) separating a protein product that comprises insoluble wheat protein and microorganism from the medium, and (l) separating an ethanol product from the medium.

Another aspect of the invention is a protein composition that comprises at least about 60 wt % protein on a dry solids basis, no more than about 1.5 wt % reducing sugars on a dry solids basis, and no more than about 10 wt % moisture. The composition has a L*value of at least about 70, an a*value of no greater than about 5, and a b* value of no greater than about 20 on the Hunter color scale. In certain embodiments, the composition has an a* value of no greater than about 3 and a b*value of no greater than about 15 on the Hunter color scale. Some embodiments of the composition comprise at least about 30% higher concentrations of asparagine, alanine, and lysine on a dry solids basis than are found in vital wheat gluten. The composition can suitably be produced by the process steps described above.

### BRIEF DESCRIPTION OF THE DRAWINGS

FIG. 1 is a process flow diagram of one embodiment of the present invention.

### DESCRIPTION OF ILLUSTRATIVE EMBODIMENTS

One embodiment of the invention is a process that can produce dextrose, a high protein product, and a high fiber product from wheat. Other grains such as barley, rice, or rye can be used, as well as combinations of two or more of these grains.

In one embodiment of the process, the feed grain can be at least partially dehulled by milling, for example in a Buhler mill or a Satake mill. This removes some of the bran in the feed grain, and tends to reduce the yield of starch and protein.

The process involves steeping wheat, or partially dehulled wheat in an aqueous liquid to produce softened wheat. The wheat grains can be steeped, for example, in water or an aqueous solution to which SO₂ and HCl have been added. These chemicals are added to soften the wheat and to remove some of the calcium and magnesium that are present.

The softened wheat is then milled. The milled wheat is then liquefied by contacting it with amylase and heating it to a temperature of at least about 50° C., or in some cases at least about 55° C. or at least about 70° C. This produces a liquefied material. The liquefied material is at least partially saccharified by contacting it with amyloglucosidase at a temperature of at least about 50° C., or in some cases at least about 55° C. or at least about 70° C. This saccharification step results in a first saccharified material, which is then processed in a separation step. The separation, which can be performed, for example, by screening, separates fiber and wheat germ from the first saccharified material. The separated fiber and wheat germ are suitable for use as animal feed. The screened material that remains is substantially free of fiber and wheat germ (i.e., the combined concentration of fiber and germ in the screened material is no more than about 5% by weight, and in some embodiments is much less than 5%, for example 1% or less).

The screened material is then further saccharified by contacting it with amyloglucosidase at temperature of at least about 50° C., or in some cases at least about 55° C. or at least about 70° C., producing a second saccharified material. Optionally, prior to or during this and the previous saccharification step, the material can be contacted with phospholipase in addition to amyloglucosidase. This second saccharified material is then filtered using a membrane, for example by ultrafiltration or microfiltration. Optionally, pentosanase can be added to the second saccharified material prior to or during ultrafiltration. The ultrafiltration step produces a permeate that comprises primarily dextrose and other soluble components and a retentate that comprises insoluble protein. “Primarily dextrose and other soluble components” in this context means that the listed constituents make up more than 50% by weight of the permeate on a dry solids basis, in some cases at least 75%.

The permeate is purified by chromatographic separation, producing a purified dextrose stream. In most instances, it is desirable to pre-treat the permeate before the chromatographic separation. The pre-treatment can comprise contacting the permeate with activated carbon and also removing divalent cations from the permeate. For example, divalent cations such as Mg⁺⁺ and/or Ca⁺⁺ can be removed by contacting the permeate with a weak acid cation resin ion exchanger and/or a strong acid cation exchanger. In certain embodiments of the process, the permeate (or a portion of the weak acid ion exchanger product) can be contacted on a strong acid cation resin ion exchanger in the hydrogen form and blended with the weak acid cation ion exchanger product to reduce the pH instead of using acid which increases the ash in solution. The chromatographic separation can be done by simulated moving bed chromatography. In one embodiment of the process, the simulated moving bed chromatography is done in a plurality of columns that each comprises strong acid cation resin ion exchanger.

A dextrose product can be recovered from the purified dextrose stream. In some instances, this product will have a very high level of purity. For example, the product in some instances can comprise, on a dry solids basis, at least about 97% by weight dextrose, no more than about 2% by weight maltose, no more than about 0.15% ash, and no more than about 0.1% protein. This syrup may require further refining, and the degree of refining will depend on the market requirements for the dextrose syrup. Treatment with carbon will reduce the color and protein, and treatment with cation and anion exchangers will reduce the ash and protein.

Temperature, pH, and other process conditions in the various steps of the process can vary in different embodiments of the process. In one embodiment, the following process conditions are used. The aqueous liquid is maintained at a temperature of about 40-60° C. and pH of about 5-6 during steeping. The milled wheat is maintained at a temperature of about 80-120° C. for about 0.5-5.0 hours during liquefying. The liquefied material is cooled to about 55-65° C. prior to saccharifying. In the first saccharification step, the liquefied material is maintained at a temperature of about 55-68° C. and a pH of about 4-4.5 for about 2-15 hours, and in the second saccharification step, the screened material is maintained at a temperature of about 55-68° C. for about 10-60 hours. The second saccharified material is maintained at a temperature of about 60-80° C. during ultrafiltration.

The process can include the following steps, which produce a high-protein product that contains relatively little dextrose. The retentate from the membrane filtration, or a portion of the retentate, combined with the raffinate from the chromatographic separation, is fermented, producing a broth that has a decreased saccharide content and an increased content of insoluble protein, relative to the original retentate. The increase in the insoluble protein is because of the yeast or other microorganism from the fermentation. Insoluble material can be separated from the broth, and a product that is rich in insoluble protein and low in dextrose content can be recovered therefrom.

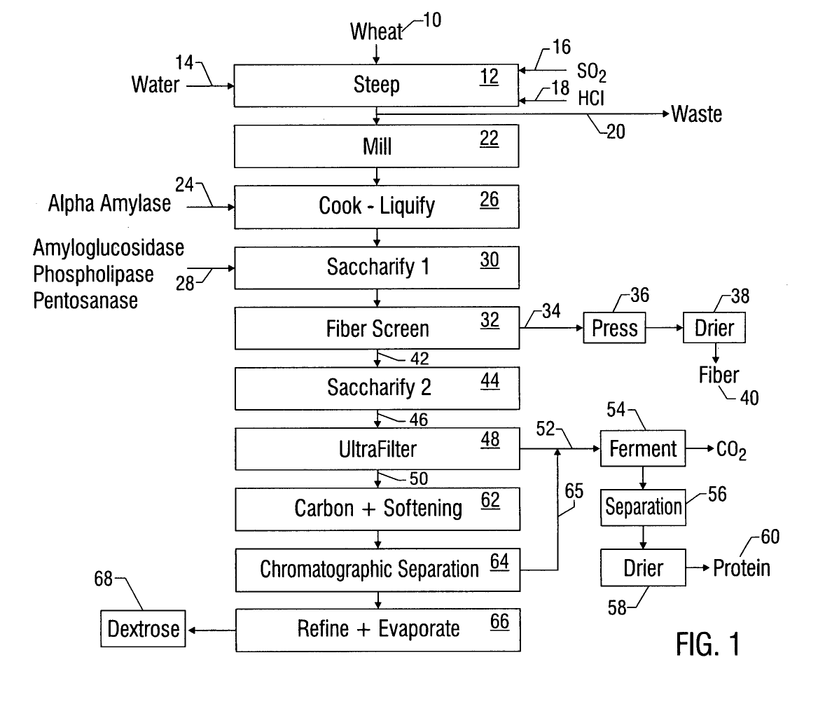

The following is a more detailed description of certain specific embodiments of the invention. FIG. 1 is a process flow diagram for one version of the process.

The feed material for the process is whole grain wheat cereal 10. The wheat is cleaned of straw and stones, usually by screening. The cleaned whole wheat is added to a steep tank 12, where it is soaked in water 14 to soften the grain. Sulfur dioxide 16 and hydrochloric acid 18 are also added to the steep tank 12 to increase the removal of both calcium and magnesium. The steeping system can be either batch or continuous and the residence time of the wheat is about 16 hours. The temperature during the steep is 50° C. The steeping, like various other steps in the process, can be performed continuously, or in batch or semi-batch mode.

The wheat is then separated from the steep water with a screen and a waste stream 20 can be withdrawn. The steeped wheat is milled 22, and this mill can be one or more of a variety of mills, but preferably is a toothed disc mill. The pH of the milled wheat slurry is adjusted to 5.6 and alpha amylase enzyme 24 is added to liquefy the starch content of the stream. The temperature is increased to about 80-110° C. and the operation can be carried out in a starch cooker 26. The dry solids content of the liquefied material at this stage of the operation is about 15 to 20% d.s. The material is held for about 5 minutes, for example in a length of pipe sized for the purpose, to allow the liquefaction time to proceed. The slurry is then flashed to 98° C. and held for about 3 hours to allow liquefaction to complete.

The temperature of the liquefied material is then reduced to 62° C. and the pH adjusted to 4.2 and amyloglucosidase enzyme 28 is added. It is held for 2 to 12 hours to allow saccharification 30 to start and the viscosity to reduce. This partially-saccharified slurry is then screened 32 to remove fiber and germs. This can be done in a number of stages, using water to wash the sugars from the fiber in a counter-current manner. This water can be added in the final fiber screen, with the wash water then progressing to the first screen. Suitable types of screens include 120 degree bent screens and centrifugal screens.

The washed fiber and germ 34 can be pressed, for example in a screw press 36, and then dried 38, milled, and sold as an animal feed 40.

The slurry 42 that passes through the fiber screens contains relatively fine insoluble protein. More amyloglucosidase enzyme and phospholipase enzyme can be added and the slurry is fed to batch tanks 44. The total saccharification time in these tanks can be typically 24 to 48 hours. The temperature during this time is held at 62° C. The saccharified slurry 46 can then be dosed with pentosanase enzyme and filtered using a crossflow ultra-filter, or micro-filter membrane system 48. This can be, for example, a ceramic ultra-filter with 6 mm diameter channels, but could also be other types of crossflow units, for example spiral-wrapped membrane modules with a large spacing, or tubular units. Other types of conventional filters could be used, but ideally the cake should not be mixed with filter aid as this will reduce its value. The temperature during this filtration should be selected to give good filtration, but can typically be 65 to 75° C. The dry solids (d.s.) content of the ultrafiltration feed is about 15%. The crossflow membrane system separates the slurry into a clarified stream 50, which is the permeate, and a retentate stream 52 containing the insoluble protein.

It is also possible to add amyloglucosidase, phospholipase, and pentosanase at the same point in the process, for example prior to the screening 32, rather than by separate additions at different points in the process.

It is possible to wash soluble sugars from the retentate 52 by adding water and then separating the liquid and solids streams. This can be carried out in a centrifuge or another crossflow ultra-filter (not shown in FIG. 1). A disc stack centrifuge can be used for this wash stage. The liquid stream containing sugars optionally can be sent back to the feed to the crossflow membrane filter, which improves the yield of dextrose.

The slurry stream discharged from the centrifuge, which is typically about 30% d.s. suspended solids, can be fed to a fermenter 54. This can be an aerobic fermenter that can ferment yeast, for example either Saccharomyces or Torula. The yeast or other microorganism should be one that will grow using the dextrose, increasing the quality of protein, and that is acceptable as an animal feed. Suitable microorganisms include, but are not limited to Saccharomyces cerevisiae, Torulopsis utilis (also called Torulopsis utilis thermophilis, and Candida utilis), Kluyveromyces lactis, and Kluyveromyces fragilis.

The yeast ferments most or all of the remaining dextrose, maltose and higher sugars, plus pentosans and soluble protein, to produce a yield of yeast. This yeast increases the amount of insoluble protein present. The insoluble protein comprises the insoluble protein from the wheat or other cereal, plus the yeast that has been grown in the fermenter. The fermenter can be a batch unit or can be continuous, running for several days, and requires a means of providing enough dissolved oxygen for the fermentation, such as a vortex tube. Typical temperature and pH are 28° C. and 4.0 and the liquid portion of the feed is at about 7% dry solids.

In another embodiment of the process, the fermentation can be done under anaerobic conditions. This will lead to the production of ethanol and a somewhat reduced yield of yeast. Separation techniques can be used to recover the ethanol as a separate product.

The insoluble protein and yeast can be separated from the broth produced in the fermenter using a disc stack centrifuge or other separation device 56. Other types of centrifuge, or a membrane or other filter, could also be used. The type of separator will determine the protein content of the protein product. Using a disc stack centrifuge with water washing can give over 80% protein on a dry solids basis. Using a membrane can give over 60% protein on a dry solids basis. The insoluble protein can be about 30% d.s. insoluble solids, and can be dried 58 to produce a valuable protein product 60 containing 80% protein on a dry solids basis (dsb). A common drier that can be used is a ring drier, but a flash, spray or other type of drier can also be used. The typical outlet temperature in a ring drier would be 75 to 95° C., giving a moisture content of 4 to 6%. The protein product 60 typically has a low content of reducing sugars (e.g., dextrose), in some cases no more than about 1.5% by weight.

The protein-rich product 60 will typically have low reducing sugar content (e.g., less than about 1.5% by weight) and color similar to conventional dried vital wheat gluten. The low content of reducing sugar makes the product easier to dry. High dextrose content in a protein product could cause charring or even fire during drying of the product. The yield of protein, in some embodiments of the process, can be considerably higher than in a conventional wheat process, for example as much as 13 wt % or even higher. Although the gluten can be denatured by the heating in the process, the increased gluten yield can maintain the total value of the protein product as compared to that produced by a conventional wheat process.

In some embodiments of the process, after recovery and drying, the protein-rich product is a composition that comprises at least 60% by weight protein, no more than about 1.5% by weight reducing sugars (e.g., dextrose), and about 5% moisture. Unlike vital wheat gluten, this composition is non-binding, and unlike corn gluten meal, it is not yellow. When measured on the Hunter scale the value of b*, where a higher value represents a more yellow color, is relatively low. The protein-rich product has a value typically less than half the value given by corn gluten meal, a value of b* of about 14 compared to 35. The protein can comprise a mixture of wheat protein and yeast protein, and in one embodiment, the yeast protein is about 5-30% by weight of the total protein present in the composition. The yeast present in the protein-rich product can give this product increased values of the valuable amino acids asparagine, alanine and lysine, 30% to 100% higher than in conventional wheat gluten. This product is suitable for a number of uses, among which are food for salmon, trout, and other fish.

In one embodiment of the invention, the composition comprises concentrations of asparagine, alanine, and lysine that are at least about 30% higher on a dry solids basis than are typically found in vital wheat gluten. In another embodiment, the composition comprises at least about 4.4 wt % asparagine, at least about 3 wt % alanine, and at least about 2.5 wt % lysine on a dry solids basis.

The clarified liquid stream 50 from the crossflow membrane filter contains primarily dextrose, with some higher sugars, ash and soluble protein. This stream can be purified in a chromatographic separator 64, but often needs treatment prior to being fed to this unit. The pre-treatment comprises first passing the stream over activated carbon 62, preferably granulated, but powdered carbon could also be used.

The next pre-treatment step is to soften the liquor to remove divalent ions, primarily calcium and magnesium. This can be done using a weak acid cation (WAC) resin ion exchanger, where the calcium and magnesium ions are replaced with sodium ions. With conventional syrups the equilibrium pH exiting the weak acid cation softening resin would be 3.8 to 4.0. However due to the presence of materials such as soluble protein, the exit pH can be in the range 5.7 to 6.0. This relatively high pH can lead to color generation at increased temperature and can be reduced by the addition of acid, usually sulfuric or hydrochloric. However this leads to an increase in ash content that needs to be removed at a later stage in the process. An alternative to adding acid is to use a strong acid cation resin (SAC) to reduce the pH. In order to reach the required value of pH 4.0, part of the permeate or part of the stream exiting the weak acid cation softening resin can be processed and then blended back into the main stream. The pH of the SAC resin is 1.8, and the blended stream is at pH 4.0.

The material treated by ion exchange can be evaporated to 60 Brix before feeding to the chromatographic separator. The chromatographic separator 64 can be in the form of a simulated moving bed and can run continuously. This can comprise six or more columns filled with a strong acid cation resin in the sodium form. This will separate the dextrose from the maltose, oligosaccharides, ash and soluble protein that is in the feed. The final product from the chromatographic separator typically has a dextrose content of over 97%, maltose of about 2%, ash of 0.15%, and protein of 0.1%. This separation produces a raffinate 65, which is fed to the fermenter 54.

One advantage of simulated moving bed chromatography over techniques such as crystallization is increased yield of dextrose. Example 4 below describes an experiment in which crystallization gave a dextrose yield of 39.5%, in contrast to a yield of 92% from simulated moving bed chromatography in Example 1. In some cases, additional crystallization steps would not be economical due to the low purity of the mother liquor.

Finally the syrup can be evaporated 66, typically up to 70-71 Brix, yielding the dextrose product 68.

A dextrose material such as this can be used as a high quality fermentation feed. Also, depending on the final application of the dextrose syrup, it can be further refined with carbon and ion exchange to remove color and ash, and evaporated to produce a refined dextrose syrup suitable for use in the food industry.

The yield of starch to dextrose is considerably higher in this process than in the conventional wheat process. Typically in the conventional process, 47% of the starch that is in the wheat (on a dry solids basis) can be converted to dextrose. In the process of the present invention, as much as 61% of the starch can be converted to dextrose.

Various embodiments of the invention can be further understood from the following examples.

### EXAMPLE 1

Whole wheat was pre-screened to remove straw and stones. It was fed continuously at a rate of 400 kg/hr into the top of a steep tank. This tank was vertical with a conical bottom and a volume of 20 m³. Water was fed into the steep tank from the bottom to flow counter-current to the wheat, which flowed down and exited the tank from the bottom of the cone. Into the water was added 1000 ppm of SO₂ and 150 ppm of hydrochloric acid.

The residence time of the wheat in the steep tank was 16 hours, the temperature was 48° C. and the water flow was 800 liters/hour. The wheat exiting from the steep tank was first screened on a 1000 micron screen to separate the wheat from water. It was then milled in a mill which has a rotating toothed disc. The steep water was sent to waste.

The milled wheat in a water slurry was then held in a small buffer tank. The pH of the slurry was adjusted to 5.6 using caustic soda. Amylase enzyme, Liquozyme Supra produced by Novozyme, was added at a rate of 0.4 kg/hr at this point. It was pumped from this tank at a flow of 1.5 m³/hour to a jet cooker. This cooker was supplied with steam and the temperature of the mix was controlled at 110° C. After the jet cooker, the mix was held for 5 minutes in a length of pipe to allow liquefaction of the starch to proceed before the pressure was released by passing through a valve, allowing the mix to pass into a flash vessel at atmospheric pressure, where the temperature dropped to 98° C.

The slurry was then held in tanks for 3 hours at 98° C. to allow liquefaction to complete. The pH was readjusted to 5.6 using sulfuric acid and a further 0.8 kg/hour of Liquozyme Supra was added. It was then pumped to a further flash vessel at 300 mbar where the temperature dropped to 62° C. The pH was reduced to 4.2 and an amyloglucosidase enzyme, Dextrozyme DX supplied by Novozyme, was added at a rate of 1.08 kg/hour. Also added at this point were two other enzymes, a phospholipase enzyme called Finizyme W, supplied by Novozymes, which was added at 0.12 kg/hour, and a pentosanase, Shearzyme Plus, supplied by Novozyme, which was added at 0.8 kg/hour. The material was held for 8 hours in a tank to allow saccharification to proceed to thin the mixture. At this stage the material had only been partially saccharified in this first stage saccharification tank. This allows the viscosity to be low enough so that the fiber can be removed by screening. The screens used were four DSM type screens and one Centrisieve. The fibers were removed from the mixture and washed with water using a counter-current arrangement. The material from the first stage saccharification tank was fed to the first DSM screen which has a 50 micron screen. The fiber from this screen passes to the second, third and fourth screens being washed in a counter-current manner. These all had 75 micron screens. The fifth screen was a centrifugal sieve made by Larsson of Sweden. It was fitted with a 200 micron screen and fresh water was used on this screen for washing. This fiber was collected and its composition is given in Table 1.

TABLE 1

| | DS | Starch | Fiber | Protein | Fat | Dextrose | Fructose |
|---|---|---|---|---|---|---|---|
| | (wt %) | (wt % dsb) | (wt % dsb) | (wt % dsb) | (wt % dsb) | (wt % dsb) | (wt % dsb) |
| Wheat | 86.6 | 68.9 | 1.7 | 12.3 | 2.5 | — | — |
| Fiber | 16.2 | 16.2 | 14.3 | 13.8 | 12.8 | 4.0 | — |
| Permeate | 14.1 | — | — | 3.9 | — | 82.2 | 0.9 |
| Protein | 95.6 | 2.9 | 8.6 | 80.0 | 8.0 | 0.05 | 0.07 |

The de-fibered liquid from screen I was sent to a second stage of saccharification where it was held in four 12 m³ tanks, giving a total residence time of 24 hours. The liquid from the second saccharification step was sent to the feed tank of a crossflow ceramic membrane. The pH was adjusted to 3.8 with sulfuric acid. This crossflow membrane unit had ceramic membranes supplied by SCT of France and had a total of 50 m² membrane area. These ceramic membranes had channels of 6 mm diameter. It was operated at 75° C. and with a concentration factor of 5 and provided a highly clarified stream (permeate) containing dextrose and other soluble impurities, with a composition as shown in Table 1. Concentrated in the retentate was the material filtered out from the feed which contained insoluble protein. This material was fed to a disc stack self-cleaning centrifuge. The overflow from this centrifuge was fed back to the first stage saccharification tank, and the underflow was a stream in which the main insoluble component was insoluble wheat protein.

The filtered material (permeate) was then heated to 75° C. and fed to the first of two vessels containing granular activated carbon (GAC). The flow through the GAC vessels was 2 m³/hour, giving one Bed Volume per hour, with each vessel containing 1 m³ and 500 kg.

After GAC, the liquor was softened to remove calcium and magnesium. The levels of these two divalent cations in the feed to softening was 154 ppm calcium and 635 ppm magnesium. The liquor was treated by ion exchange using a weak acid cation (WAC) resin. Two resin cells were used in series at a flow of one bed volume per hour using 1 m³ in each cell. The resin was in the combined hydrogen/sodium form and during regeneration first hydrochloric acid was used, followed by caustic soda.

The level of calcium and magnesium after treatment were 1 ppm and 5 ppm respectively. The pH of the softened liquor was then reduced from 5.7 by passing part of the stream through a strong acid cation (SAC) resin to reduce the pH to 4.0. The outlet of the material from the strong acid cation resin was pH 1.8, and by passing just part of the stream through this it gave a combined value of pH4.0, where the stream can be heated without generation of color.

The alternative to using a strong acid cation resin to reduce the pH was to add acid. Tests were carried out using sulfuric acid to reduce the pH of the softening material from the weak acid cation softener. A comparison of the two methods is shown in Table 2.

TABLE 2
SAC pH Adjustment

| | | | mono- | | | |
|---|---|---|---|---|---|---|
| | | | saccha- | | | |
| | | DS | rides | Protein | Ash | |
| | | wt % | % d.s.b. | % d.s.b. | % d.s.b. | pH |
| WAC Product | | 14.6 | 89.9 | 3.6 | 2.9 | 5.7 |
| WAC Product | SMB | 63 | 89.4 | 3.6 | 3.3 | 4.0 |
| pH adjustment | Feed | | | | | |
| WAC Product | | 14.6 | 89.9 | 3.6 | 2.9 | 5.7 |
| SAC Product | | 13.4 | 91.1 | 0.34 | 0.19 | 1.8 |
| Combined WAC | SMB | 63 | 91 | 2.4 | 2.05 | 4.0 |
| and SAC Product | Feed | | | | | |

N.B. Softened simulated moving bed feed (SMB feed) evaporated to 63 Brix (Bx) in both cases.

The softened liquor was then evaporated from 14% d.s. to 60% d.s. in a falling film evaporator. After evaporation, the syrup was filtered using a Carlson 40 plate filter press with XE 90H pads which have a pore size of 2 microns.

This concentrated liquor was used as the feed to a chromatographic separator. This was a simulated moving bed unit (SMB) with six cells. Each cell contained 2 m³ of a strong acid cation resin in the sodium form, Purolite PCR-642. The unit was fed at 400 liters per hour with the feed point rotated around the six cells at regular intervals. Elution water was also fed into the SMB and product and raffinate were produced by the SMB and collected in tanks.

Table 3 shows the feed, product and raffinate compositions, showing the increase in dextrose and decrease in impurities of the liquor. The yield of dextrose from the SMB was 92% by weight.

TABLE 3

| | | | | Total | | |
|---|---|---|---|---|---|---|
| | d.s. | Dextrose | Fructose | monosaccharides | Ash | Protein |
| | wt % | (wt % dsb) | (wt % dsb) | (wt % dsb) | (wt % dsb) | (wt % dsb) |
| Feed | 62.3 | 83.5 | 1.9 | 85.4 | 2.7 | 2.7 |
| Product | 32.2 | 93.5 | 1.4 | 94.9 | 0.61 | 0.75 |
| Raffinate | 5.4 | 40.6 | 0.98 | 41.6 | 12.3 | 5.7 |
| Refined Liquor | 29.3 | 95.8 | 1 | 96.8 | 0.1 | 0.03 |

The product from the SMB can be further refined using carbon in the form of GAC and by demineralization using cation and anion resins. The liquor at 32 d.s. was fed to two GAC columns each containing 1 m³ of GAC at 75° C. The flow through these GAC columns or cells was 350 liters/hour, giving a flow of 0.175 Bed Volumes per hour.

After treatment by carbon, the liquor can be ion exchanged to remove ash, protein and color. The temperature was first reduced to 40° C. The resins used were a strong acid cation resin and a strong base anion resin. The flow rate through the ion exchange units was 350 liters/hour, and 1 m³ of cation resin and 1 m³ of anion resin were used. The final liquor had the composition shown in Table 3, and after evaporation was of a quality that can be sold as a 96 DE (dextrose equivalent) dextrose syrup.

### EXAMPLE 2

This example illustrates the production of a protein product with a high percentage of protein using the underflow from the centrifuge separator in Example 1, plus the raffinate from the simulated moving bed, also from Example 1. These two can be mixed together and fed to an aerobic fermenter. This fermenter grew Saccharomyces cerevisiae yeast to remove sugars and increase the protein content of the protein product. The fermenter had a capacity of 40 m³ and was oxygenated using an eductor. Hydrogen peroxide was dosed into the fermenter to improve and maintain sterility. The feed rate to the fermenter was 1 m³/hour and the temperature and pH in the fermenter were 28° C. and 4.3. The fermenter was started by adding 8 m³ of feed and inoculating with 50 kg of yeast cream at 30 wt % d.s., supplied as Distillers yeast by DSM. A nitrogen source was provided using 8-12 litres/hour of 40% urea. The fermenter ran for 10 days being continuously fed and having product withdrawn.

The product from the fermenter was centrifuged to remove the insoluble protein and yeast from the liquor. This was done using a self-cleaning disc stack centrifuge. The underflow from the centrifuge containing the protein was 25% d.s. and this was dried in a 6 inch ring drier. The flow rate to the drier was 80 kg/hour and the drier operated with an inlet gas temperature of 215° C. and an outlet product temperature of 80° C. The protein product dried very well and easily in this type of drier. When the drier was opened there was no material that had stuck to the walls or classifier section of the ring drier, and no sign of charring. The composition of the protein product is shown in Table 4.

The overflow liquid fraction from the fermenter was discharged to waste.

TABLE 4

| | d.s. | Dextrose | Protein | Ash | Fat | Maltose |
|---|---|---|---|---|---|---|
| | (wt %) | (wt % dsb) | (wt % dsb) | (wt % dsb) | (wt % dsb) | (wt % dsb) |
| Feed | 10.7 | 23.9 | 66 | — | — | 0.9 |
| Dried Product | 96 | — | 83.1 | 3.0 | 8.15 | 0.05 |

The color of the protein product was measured using the Hunter method. The values for the product made using the method in examples 1 and 2 are shown in Table 5, together with the Hunter values for conventional wheat gluten and conventional corn gluten meal.

TABLE 5
Hunter Color Measurements

| Material | L* | a* | b* |
|---|---|---|---|
| Product | 75.3 | 2.0 | 14.4 |
| Conventional Wheat Gluten | 84.7 | 1.2 | 13.7 |
| Conventional Corn Gluten | 71.0 | 10.2 | 35.8 |

The Hunter scale gives three measurement readings for color, L*, a* and b*:
L* is the degree of light and dark, a high value being white and a low value being black.
a* is the degree of redness, a high value being more red.
b* is the degree of yellowness, a high value being more yellow.

The results show that although the color of the protein made by this method is similar to conventional vital wheat gluten, when compared to corn gluten it has a much lower value for b*, showing it is much less yellow in color, and a lower value of a* showing it is much less red in color.

The protein was analyzed for amino acid content and an analysis of two samples is shown in Table 6. In this table the protein produced by this method is compared with a typical commercial wheat gluten made by conventional technology.

TABLE 6
Amino Acid Content

| | | % Amino Acid | |
|---|---|---|---|
| | % Amino Acid | Wheat gluten- | Relative |
| | Protein Dsb | conventional dsb | % |
| Glutamine | 36.25% | 36.6% | 99% |
| Proline | 11.05% | 12.0% | 92.1% |
| Leucine | 7.13% | 6.7% | 106.4% |
| Phenylalanine | 4.74% | 5.8% | 81.7% |
| Serine | 4.65% | 5.4% | 86.1% |
| Valine | 3.95% | 3.8% | 103.9% |
| Asparagine | 4.39% | 3.1% | 141.6% |
| Arginine | 3.29% | 3.3% | 99.7% |
| Tyrosine | 3.11% | 3.4% | 91.47% |
| Isoleucine | 3.36% | 3.5% | 96.0% |
| Glycine | 3.15% | 3.0% | 105% |
| Alanine | 3.32% | 2.5% | 132.8% |
| Threonine | 2.65% | 2.6% | 101.9% |
| Histidine | 1.85% | 1.8% | 102.8% |
| Lysine | 2.48% | 1.6% | 155% |
| Cysteine | 2.05% | 2.2% | 93.2% |
| Methionine | 1.58% | 2.0% | 79% |
| Tryptophan | 0.91% | 0.8% | 113.7% |

The table shows a significant increase in asparagine, alanine and lysine over conventional wheat gluten, due to the presence on yeast in the protein product.

### EXAMPLE 3

A 2 liter sample of the feed to the aerobic fermenter prepared as in Example 2 was taken in a 2 liter stirred flask and adjusted to 28 to 32° C. To this were added 9.4 g of urea peroxide and 20 g of bakers yeast (Saccharomyces cerevisiae). The flask was kept stirred and fermentation allowed to proceed. This fermentation was run anaerobically in order to produce ethanol.

Samples were taken during the fermentation and these were analyzed for dextrose and ethanol using HPLC. After 38 hours the fermenter broth was centrifuged. The solids were at 25% dry solids and the protein content was 79.9% on a dry solids basis.

The results obtained are shown in Table 7.

TABLE 7

| Time | Subsample | Glucose | Ethanol |
|---|---|---|---|
| hrs | wt % DS | wt % DS | wt % DS |
| 0 | 5.39 | 20.95 | 0 |
| 0.5 | 5.43 | 19.42 | 0.69 |
| 12.5 | 4.74 | 0.08 | 10.85 |
| 14 | 4.58 | 0.09 | 10.60 |
| 16 | 4.77 | 0.14 | 9.99 |
| 18 | 4.54 | 0.31 | 10.62 |
| 20 | 4.56 | 0.29 | 10.51 |
| 24 | 4.59 | 0.27 | 10.20 |
| 36 | 4.53 | 0.0 | 10.60 |
| 38 | 4.35 | 0.0 | 10.20 |

### EXAMPLE 4

Approximately 370 ml of permeate at 13.6% dry solids produced as in Example 1 were evaporated in a laboratory evaporator to 72% dry solids. The temperature of this evaporation was 60° C. This provided 66 g of syrup with a dextrose content of 80%. The syrup was then filtered through a 1.6 micron filter with a small amount of Celite filter aid remove the turbidity that had formed by evaporating. The syrup was then cooled to 40° C. in a 100 ml glass rotary vessel. To this syrup 0.66 g of pure dextrose crystals were added as seed to initiate crystallization and it was rotated steadily to ensure gentle mixing of the viscous syrup occurred. It was held at 40° C. for 48 hours and then reduced to 30° C. over 10 hours. It was then held at 30° C. for a further 40 hours.

The crystals that had grown from the cooled syrup were then separated by filtration under vacuum using a GF/A (1.6 micron) filter paper. The crystals were washed using 5% of saturated dextrose solution. The crystals were dried in an oven overnight at 65° C. and weighted. The moisture content was 79% showing that the crystals were in the monohydrate form. The quantity of crystals collected represented a yield of 39.5%. The results are shown in Table 8.

TABLE 8

| | Dry Solids | Dextrose | Maltose | Fructose | Weight |
|---|---|---|---|---|---|
| | % | % dsb | % dsb | % dsb | g |
| Feed syrup | 76.0 | 79.51 | 3.4 | 1.87 | 47.1 |
| Crystals | 79 | 97.4 | — | — | 15.95 |

### EXAMPLE 5

A batch of whole wheat weighing 200 kg (dry solids (DS) 88.8%, protein 11.6% and ash 1.4%) was prepared by screening to remove stones and other unwanted material. This 200 kg of wheat was mixed with 550 liters of water in a 1 cu. meter tank. The mix was heated and kept at a temperature of 50° C. and sulphur dioxide was added as a 6% weight solution to a total of 1000 ppm. The pH of the mix was pH 6.1 and it was held for 18 hours.

At the end of this time the softened whole wheat was milled in an Andriz Sprout Bauer mill, with the complete batch being milled in 2 hours. To this whole batch of slurried wheat 94 g of an alpha-amylase enzyme, Liquozyme Supra, supplied by Novozyme, was added, and the batch was then jet cooked at 100° C. This took a total time of 1 hour. It was then held for a further 3 hours at 85° C. in the 1 cubic meter tank for liquefaction to complete.

The temperature of the liquefied mixture was reduced to 62° C., and the pH was reduced to pH 4.2 with dilute hydrochloric acid. Three enzymes were then added to the mix. These were 165 g of an amyloglucosidase enzyme, Dextrozyme DX, 155 g of a pentosanase enzyme, Shearzyme Plus, and 24 g of a phospholipase enzyme, Finizym W. All of these enzymes were supplied by Novozyme. The batch was then held for 4 hours to allow these enzymes to act.

The complete batch of material was then screened using a Sweco vibrating screen with a 100 micron mesh, the screening time being about 2 hours. This screening removed fiber from the slurry. About 800 liters of slurry were produced.

200 liters of this slurry were held in a tank for a further 36 hours at 62° C. to allow saccharification to complete. The batch, with an analysis as shown in Table 9, was then filtered using an ultrafilter having 2 square meters of filtration area. The ultrafilter membranes were ceramic units with a pore size of 0.05 micron and were supplied by SCT of France. The temperature during this ultrafiltration was maintained at 62° C. and the total volume of retentate was reduced by a factor of 3 to give 67 liters. The analyses of the filtered permeate and the retentate are shown in Table 9.

The retentate was then diafiltered twice to remove dextrose. For the first diafiltration 50 liters of water was added and 50 liters of permeate were collected. This was repeated with the addition of 40 liters of water and the collection of 40 liters of permeate.

The resulting diafiltered retentate slurry contained protein and its analysis is shown in Table 9. Approximately 55 liters of this were collected and refrigerated prior to drying.

Two different driers were tested for this material. These were a spray drier and a ring drier.

The spray drier was a 1 meter diameter pilot unit. The nozzle used was a disc, a two fluid, flat spray type. The feed solids were measured at 12.5% ds and had a creamy color. The atomizing pressure was started at 4.0 Barg and then raised to 5.0 Barg after 15 minutes as no product was coming into the collecting chamber. The inlet temperature was kept at 250° C. and the outlet temperature maintained at 95° C. The plant was run for just over one hour and was stopped after 25 liters of material had been fed into the drier because no product had collected in the collecting chamber.

The drier was opened and the dried material was found to be stuck to the walls and ceiling of the drier chamber. This was scraped off and a total of 1.16 kg collected with a moisture content of 12.4%. Some of this material had charred, particularly the material stuck to the ceiling of the drying chamber.

It was concluded that spray drying could not be used commercially to dry a wheat protein product made using this procedure.

The second drier used was a pilot ring drier with a 3 inch ring with a classifier and a disintegrator. This type of drier cannot be fed with a slurry and in order to feed it some of the slurry was mixed with some of the dried powder produced by the spray drier. Portions of these were mixed together to give a feed material with a moisture content of 26.4%, which was judged to be a mixture suitable for feeding to the ring drier. This material was fed to the ring drier using an air inlet temperature of 250° C. The feed rate was maintained in an attempt to keep an outlet temperature of 95° C. The unit was unstable with the inlet air temperature changing, indicating that the air flow was not stable. Product was collected and the moisture content measured at 12.4% dry solids, and the analysis as in Table 9. On dismantling the drier it was found that material had stuck to the drier classifier, blocking the passage of air and preventing solids from recycling around the ring of the drier. The material was partially charred.

It was concluded that it would be difficult to dry material made using this procedure in a commercial ring drier because it tended to stick to the walls of the drier, particularly the classifying section, which is very important to the correct operation of this type of drier.

TABLE 9

| | DS | | | | | |
|---|---|---|---|---|---|---|
| | Wt % | Protein | Glucose | Fructose | Maltose | Ash |
| Feed to | 17.2 | 10.4 | 72.7 | 1.2 | 2.4 | 1.5 |
| membrane | | | | | | |
| Permeate from | 15.1 | 0.4 | 83.0 | 1.5 | 2.7 | 19.0 |
| membrane | | | | | | |
| Retentate from | 19.6 | 25.7 | 57.6 | 1.2 | 2.0 | 1.6 |
| membrane | | | | | | |
| Retentate after | 12.0 | 33.9 | 47.3 | 0.8 | 1.6 | 2.6 |
| diafiltration | | | | | | |
| Dried product | 87.6 | 36.8 | 36.7 | 0.9 | 1.1 | 1.8 |

(All values for individual components are wt % on a dry solids basis.)

TABLE 10
Hunter Measurement of Color

| Material | L* | a* | b* |
|---|---|---|---|
| Product - Example 1 and 2 | 75.3 | 2.0 | 14.4 |
| Product - Example 5 | 62.3 | 4.7 | 17.8 |

As discussed above, the Hunter scale gives three measurement readings for color, L*, a* and b*:
L* is the degree of light and dark, a high value being white and a low value being black.
a* is the degree of redness, a high value being more red.
b* is the degree of yellowness, a high value being more yellow.

The results for the protein made in Examples 1 and 2 show that the material made in this Example 5 is darker, with a lower L*. This is an indication of the degree of charring that occurred in the drier. The sample was noticeably darker when viewed by eye.

The preceding description is not intended to be an exhaustive list of every possible embodiment of the present invention. Persons skilled in the art will recognize that modifications could be made to the embodiments described above which would remain within the scope of the following claims.

We claim:

1. A process comprising:
(a) steeping at least one of wheat, barley, rye, or rice in an aqueous liquid to produce softened grain;
(b) milling the softened grain to produce milled grain;
(c) liquefying the milled grain by contacting it with amylase and heating it to a temperature of at least about 50° C., producing a liquefied material;
(d) at least partially saccharifying the liquefied material by contacting it with amyloglucosidase at a temperature of at least about 50° C., producing a first saccharified material;
(e) separating fiber and germ from the first saccharified material, producing a screened material that is substantially free of fiber and germ;
(f) further saccharifying the screened material by contacting it with amyloglucosidase at a temperature of at least about 50° C., producing a second saccharified material;
(g) membrane filtering the second saccharified material, producing a permeate that comprises primarily dextrose and other soluble components and a retentate that comprises insoluble protein; and
(h) purifying the permeate by chromatographic separation, producing a purified dextrose stream.

2. The process of claim 1, further comprising at least partially dehulling the at least one of wheat, barley, rye, or rice prior to the steeping.

3. The process of claim 1, wherein the chromatographic separation further produces a raffinate, and the process further comprises:
(i) combining the retentate from the membrane filtration and the raffinate from the chromatographic separation to form a fermentation medium;
(j) fermenting the fermentation medium aerobically with a microorganism; and
(k) separating a protein product that comprises insoluble wheat protein and microorganism from the medium.

4. The process of claim 3, further comprising:
(l) drying the protein product.

5. The process of claim 1, further comprising treating the permeate with activated carbon and removing divalent cations from the permeate, prior to the chromatographic separation.

6. The process of claim 5, wherein divalent cations are removed with a weak acid cation resin ion exchanger and/or a strong acid cation exchanger.

7. The process of claim 1, wherein the chromatographic separation comprises simulated moving bed chromatography.

8. The process of claim 7, wherein the simulated moving bed chromatography is done in a plurality of columns that each comprises strong acid cation resin ion exchanger.

9. The process of claim 1, further comprising recovering a dextrose product from the purified dextrose stream.

10. The process of claim 9, wherein the dextrose product comprises, on a dry solids basis, at least about 97% by weight dextrose, no more than about 2% by weight maltose, no more than about 0.15% ash, and no more than about 0.1% protein.

11. The process of claim 1, wherein during the saccharifying steps the material is also contacted with phospholipase.

12. The process of claim 1, further comprising adding SO₂ and HCl to the aqueous liquid during steeping.

13. The process of claim 1, wherein:
the aqueous liquid is maintained at a temperature of about 40-60° C. and pH of about 5-6 during steeping;
the milled grain is maintained at a temperature of about 80-120° C. for about 0.5-5.0 hours during liquefying;
the liquefied material is cooled to about 55-65° C. prior to saccharifying;
in step (d) the liquefied material is maintained at a temperature of about 55-68° C. and a pH of about 4-4.5 for about 2-15 hours;
in step (f) the screened material is maintained at a temperature of about 55-68° C. for about 10-60 hours; and
the second saccharified material is maintained at a temperature of about 60-80° C. during membrane filtration.

14. The process of claim 1, further comprising adding pentosanase to the second saccharified material prior to or during membrane filtration.

15. The process of claim 1, wherein prior to the separation of fiber and germ from the first saccharified material, the material is contacted with amyloglucosidase, phospholipase, and pentosanase.

16. The process of claim 1, further comprising fermenting the retentate from the membrane filtration, or a portion of the retentate, producing a broth having a decreased saccharide content and an increased content of insoluble protein.

17. The process of claim 16, further comprising separating insoluble material from the broth.

18. The process of claim 17, further comprising recovering an insoluble protein-rich product from the insoluble material separated from the broth.

19. The process of claim 18, wherein the insoluble protein-rich product is non-binding and has a b* color value on the Hunter scale of no greater than about 20.

20. The process of claim 19, wherein the insoluble protein-rich product has a b* color value on the Hunter scale of no greater than about 15.

21. A protein composition, comprising at least about 60 wt % protein on a dry solids basis, no more than about 1.5 wt % reducing sugars on a dry solids basis, and no more than about 10 wt % moisture; wherein the composition has a L* value of at least about 70, an a* value of no greater than about 5, and a b* value of no greater than about 20 on the Hunter color scale.

22. The composition of claim 21, wherein the composition has an a* value of no greater than about 3 and a b* value of no greater than about 15 on the Hunter color scale.

23. The composition of claim 21, wherein the composition comprises at least about a 30% higher concentration of asparagine, alanine, and lysine on a dry solids basis than vital wheat gluten.

24. The composition of claim 21, wherein the composition is produced by the process of claim 2.

25. The composition of claim 21, wherein the composition is produced by the process of claim 4.
